(19) United States
(12) Patent Application Publication
(10) Pub. No.: US 2002/0043128 A1
(43) Pub. Date: Apr. 18, 2002

(54) Support element

(76) Inventor: John Cooper, Hemel Hempstead (GB)

Correspondence Address: James G. Gatto, Esq., MINTZ LEVIN COHN FERRIS GLOVSKY AND POPEO PC, 11911 Freedom Drive, Suite 400, Reston, VA, 20190, US

(21) Appl. No.: 09/893,751

(22) Filed: Jun. 29, 2001

(30) Foreign Application Priority Data
Jun. 30, 2000 (GB) 0016203.2

(51) Int. Cl. F16H 57/02

(52) U.S. Cl. 74/606 R

(57) ABSTRACT

A support element for supporting bearings that rotatably support shafts, gears and the like within a transmission is described. The support element is formed separately from the transmission casing. During assembly of the transmission components can be attached to the support element prior to being inserted into the casing. A second support element may be provided to which the components can also be attached. The two support elements and attached components can therefore be inserted into the casing as an assembled module.

### FIELD OF THE INVENTION

The present invention relates to a support for components within a casing.

### BACKGROUND OF THE INVENTION

In the prior art a case for a transmission has been profiled so as to engage bearings which rotatably support shafts, gears and the like within a transmission. This requires that the case be sufficiently strong to resist deformation arising from forces occurring whilst the transmission is in use. The applicant has realised that the use of the case in this way can require the case to be unnecessarily heavy.

It would therefore be advantageous to provide a support that enables the design of the support to be optimised for its task whilst also allowing the weight of the case to be reduced.

### SUMMARY OF THE INVENTION

According to a first aspect of the present invention, there is provided a support for components of a transmission, said support being formed separately from a case for said transmission.

Preferably the support is profiled so as to provide regions for supporting bearings, the support regions not all lying in a single plane.

Advantageously the plate serves to reduce and/or spread loads at the case. In general the shafts of the transmission would, in use, experience forces urging the axes of the shafts to move with respect to one another. Where drivingly connected transmission shafts are each supported by bearings held by the support then these forces experienced during use remain substantially internal to the support and are borne by its structure. However when one shaft is supported by the support and another shaft belongs to a further component within the case, then the forces acting to cause the shafts to become displaced with respect to one another will act on the case. However, the forces can be spread over the interface between the support and the case and consequently areas of high loading can be avoided.

Thus the case can be made thinner and lighter, whilst the support can be made as strong as is required by the transmission. This is especially important within an aerospace environment where components are required to be both durable and light.

Furthermore the support may be smaller and/or lighter than the equivalent structure that would have been formed in the case to perform the same task.

Advantageously the support is in combination with a case for an aeronautical component or system.

Preferably the support and the case are made of dissimilar materials and/or by different manufacturing processes. Thus, for example, the case may be cast from aluminium for ease of manufacture and lightness whereas the support may be machined from another material, such as steel, for strength.

Because the support need not be planar, the lengths of shafts do not have to be compromised in order to lengthen them to reach the case. Alternatively, the case does not need to have bosses or other structures formed in the wall of the case to extend it inwardly towards the bearings for the shafts.

Preferably the support and case form components of a generator driven by a continuously variable transmission having first and second variable radius pulleys interconnected by a drive belt.

According to a second aspect of the present invention, there is provided a method of assembling a transmission, wherein said transmission includes a plurality of components rotatably supported by a first support element, wherein components are assembled in the housing and the first support element is then placed in position thereby securing the components and/or some of the components are attached to the first support element and introduced into the case when the first support element is placed in position.

A second and/or further supports may also be provided. This allows for the possibility of some parts of the transmission to be regarded as modules during construction or maintenance of a machine including such supports.

### BRIEF DESCRIPTION OF THE DRAWINGS

The present invention will further be described by way of example with reference to the accompanying drawing in which:

FIG. 1 shows a cross section through a constant speed generator for use in an avionics environment;

FIG. 2 is an elevation of the first support element shown in FIG. 1; and

FIG. 3 is an elevation of the second support element shown in FIG. 1.

### DETAILED DESCRIPTION OF THE INVENTION

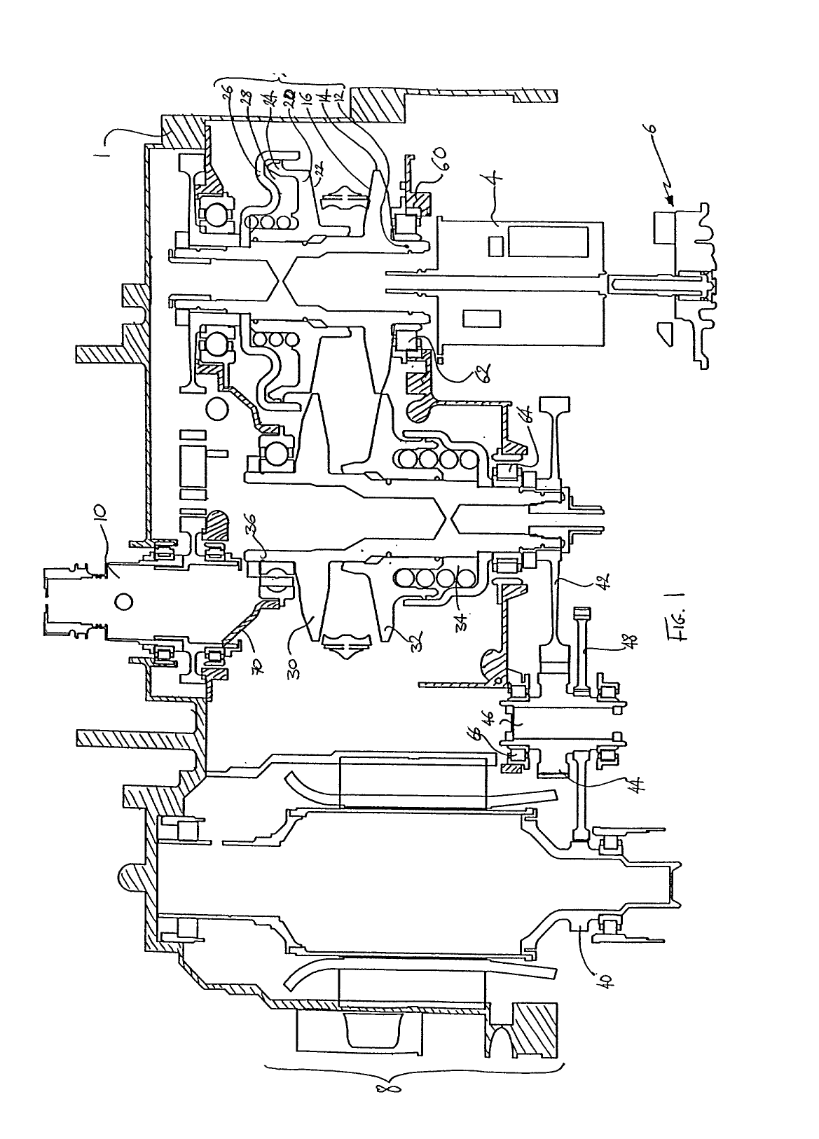

The generator shown in FIG. 1 comprises a housing 1 which encloses a continuously variable transmission utilising a belt drive, generally designated 2, a low pressure pump 4, a high pressure pump 6, a generator, generally designated 8, and an oil system disposed throughout the housing 1. Only part of the housing is shown for clarity.

The belt drive 2 enables the variable speed of an input shaft 10 which receives a drive from a spool of a gas turbine engine to be converted to a near constant speed such that the generator 8 can be run at a near constant speed. In order to do this, a first shaft 12 of the belt drive mechanism carries a flange 14 which defines an inclined surface 16 against which a drive belt bears. The shaft 12 also carries a coaxially disposed movable flange 20 drivingly connected to the shaft 12 via a splined portion (not shown). The movable flange 20 defines a further inclined surface 22 facing towards the surface 16, which surfaces serve to define a V-shaped channel whose width can be varied by changing the axial position of the flange 20 with respect to the fixed flange 14. The flange 20 has a circularly symmetric wall 24 extending towards and co-operating with a generally cup shaped element 26 carried on the shaft 12 to define a first hydraulic chamber 28 therebetween which is in fluid flow communication via a control duct (not shown) with an associated control valve. Similarly, a fixed flange 30 and a movable flange 32 are associated with a second shaft 36 and have their relative positions controlled by a second hydraulic control chamber 34. A steel segmented belt having a cross-section in the form of a trapezium, with the outer most surface being wider than the inner most surface is used to interconnect the first and second variable ratio pulleys formed between the pairs of fixed and movable flanges, respectively, in order to drivingly connect the flanges.

The position of each movable flange with respect to the associated fixed flange is controlled by the hydraulic actuators. Since the interconnecting belt is of a fixed width, moving the flanges closer together forces the belt to take a path of increased radial distance. The interconnecting belt has a fixed length, and consequently as one movable flange is moved towards its associated fixed flange, the other movable flange must move away from its associated fixed flange in order to ensure that the path from an arbitrary starting point, around one of the pulleys, to the second pulley, around the second pulley and back to the fixed arbitrary starting point remains a constant distance.

An output of the second shaft 36 is supplied to a drive gear 40 of the generator 8 via a compound step up gear formed by a gear 42 supported on the second shaft 36 which engages with an input gear 44 supported on a third shaft 46.

The third shaft 46 drivingly carries an output gear 48 which engages the gear 40.

Each of the first, second and third shafts 12, 36 and 46, respectively, are supported by bearings at positions away from the housing 1. A support element 60 extends within the housing 1 and serves to hold bearings 62, 64 and 66 of the first, second and third shafts, respectively, in a spatially fixed relationship to one another.

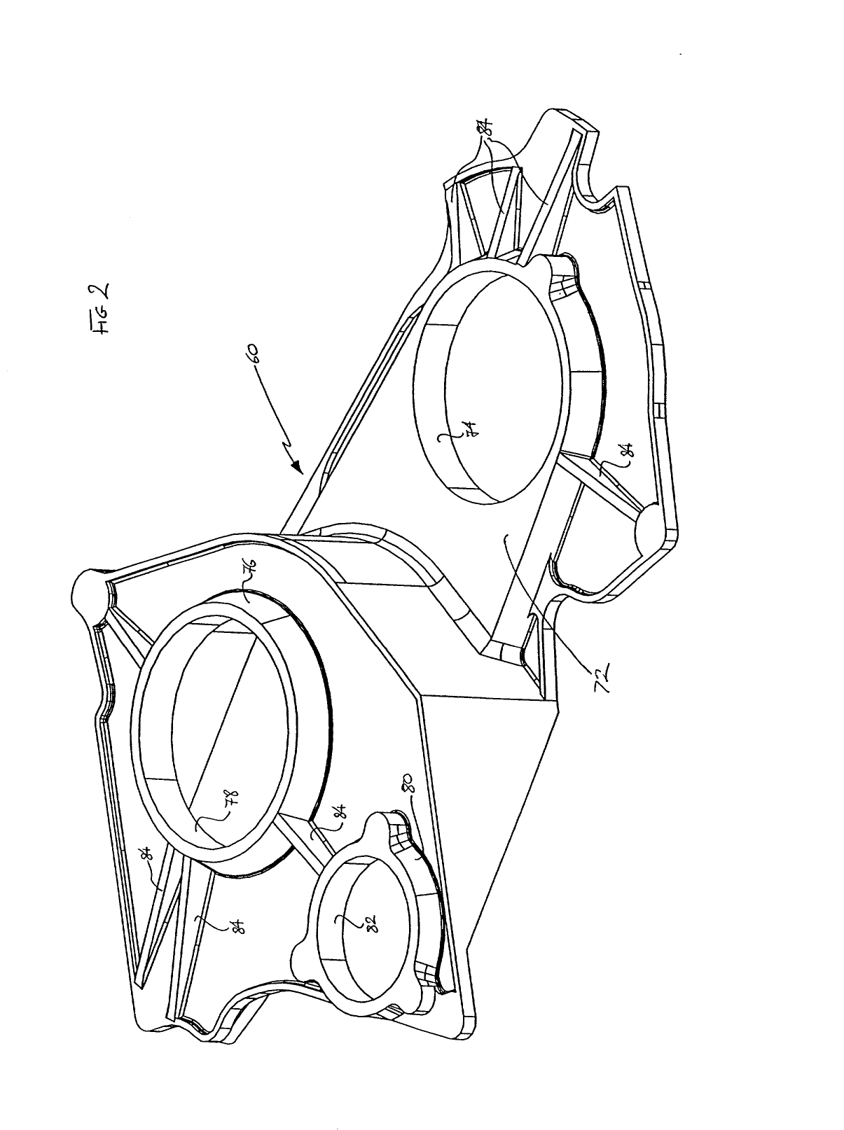

An elevation of the first support element 60 is shown in FIG. 2. A first flange 72 defines a circular recess 74 that forms the support face that supports one of the bearings 62 of the first shaft 12. A first collar 76 defines the support face 78 that supports one of the bearings 64 of the second shaft 36, whilst a second collar 80 defines the support for the bearing 66 of the third shaft 46.

In use, the drive belt is operated in a “push” mode so it exerts a force acting in such a direction as to cause the first and second shafts 12 and 36 to move apart. Similarly the forces acting between the second and third shafts can be expected to be such as to urge the shafts to move apart and to cause one shaft to wish to “walk.around” the other. The support 60 is constructed with a number of ribs 84 that help provide sufficient strength for the first support 60 to resist these forces.

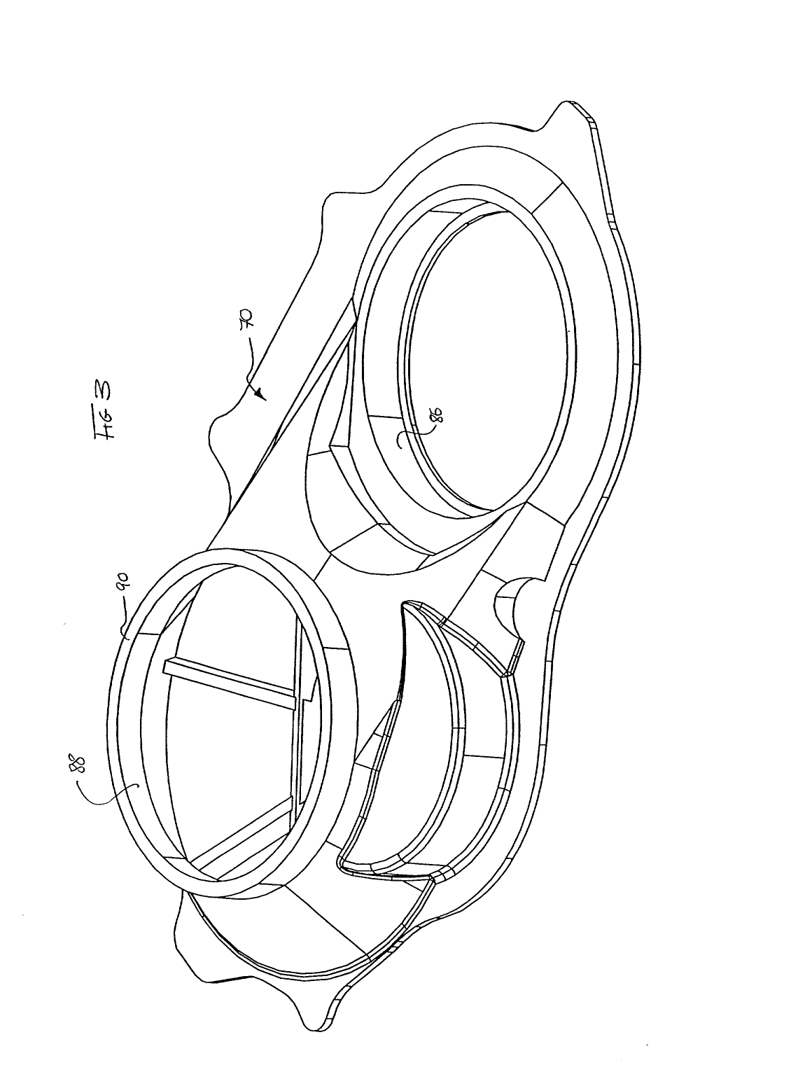

A second support element 70 is provided to support the other ends of the first and second shafts 12 and 36, and also to support one end of the input shaft 10. An elevation of the second support element 70 is shown in FIG. 3. A first support face 86 supports the end of the first shaft 12, whilst a second support face 88, defined by a collar 90, supports the end of the second shaft 36. It is important to the service life of the steel belt that precise alignment of the first and second shafts 12 and 36 is achieved, and in particular the alignment of these shafts at their ends closest to the input shaft 10. The provision of the second support element 70 that supports both the shafts allows precise alignment of the shafts to be achieved and maintained.

As shown by FIG. 2, the support 60 need not be planar, and as shown can be profiled to allow the bearings 62 to lie in a different plane to the bearings 64 and 66. This enables the transmission to be made in a compact manner, compared to the layout that would have been required if the bearings 62, 64 and 66 were supported at the housing 1.

The use of the support elements 60 and 70 enables the housing 1 to be thinner and lighter than would have been the case if it acted as a support for all the shafts. The supports also spread load against the housing's walls and enables the use of short axis drive shafts, such as shaft 12, within the finished product.

A further advantage of the use of supporting elements is that it enables a number of the transmission components to be assembled and held in place between the two support elements 60 and 70. The complete assembly may then be introduced into the casing 1, thus simplifying the overall assembly operation.

1. A support element for supporting components of a transmission assembly, said transmission assembly being located within a casing, wherein said support element is formed separately from said casing.

2. A support element according to claim 1, wherein said support element comprises a plurality of bearing support regions.

3. A support element according to claim 2, wherein said bearing support regions do not all lie in a single plane.

4. A support element according to claim 2, wherein two or more shafts are supported by said bearing support regions in alignment with each other.

5. A support element according to claim 1, wherein loads exerted on said transmission assembly are spread by said support element over an interface between said support element and said casing.

6. A support element according to claim 1, in combination with a casing for an aerospace component, wherein said support element and said casing are manufactured from different materials.

7. The combination of a support element and a casing according to claim 6, wherein said casing is cast from aluminium.

8. The combination of a support element and a casing according to claim 6, wherein said support element is machined from steel.

9. The combination of a support element and a casing according to claim 6, wherein said aerospace component comprises a generator driven by a continuously variable transmission.

10. A method of assembling a transmission, wherein said transmission includes a plurality of components rotatably supported by a support element, wherein said components are assembled in a casing and said support element is then placed in position, thereby securing said components in said casing.

11. A method of assembling a transmission, wherein said transmission includes a plurality of components rotatably supported by a first support element, wherein one or more of said plurality of components are attached to said first support element and inserted into a casing.

12. A method of assembling a transmission according to claim 11, wherein a second support element is provided to which said components are also attached prior to being inserted into said casing, thereby allowing insertion of said first and second support elements and said components as a single assembly.
